(19) United States
(12) Patent Application Publication
(10) Pub. No.: US 2024/0018038 A1
(43) Pub. Date: Jan. 18, 2024

(54) RAPID SOLIDIFICATION METHOD OF CALCAREOUS SAND

(71) Applicant: Institute of Rock and Soil Mechanics,Chinese Academy of Sciences, Wuhan (CN)

(72) Inventors: Dongsheng WEN, Wuhan (CN); Xinzhi WANG, Wuhan (CN); Haozhen DING, Wuhan (CN)

(21) Appl. No.: 17/973,586

(22) Filed: Oct. 26, 2022

(30) Foreign Application Priority Data
Jul. 15, 2022 (CN) 2022108367282

(51) Int. Cl. C04B 7/13; C04B 28/14; C04B 22/14; C04B 14/06

(52) U.S. Cl. CPC C04B 7/13; C04B 28/148; C04B 22/142; C04B 14/068; C04B 2111/70

(57) ABSTRACT

Disclosed is a rapid solidification method of calcareous sand, and the method relates to the technical field of a calcareous sand reinforcement in island reef engineering. The specific method is to achieve a rapid solidification of the calcareous sand by applying a zinc sulfate solution to the calcareous sand.

### CROSS-REFERENCE TO RELATED APPLICATIONS

This application claims priority to Chinese Patent Application No. 202210836728.2, filed on Jul. 15, 2022, the contents of which are hereby incorporated by reference.

### TECHNICAL FIELD

The application relates to the technical field of calcareous sand reinforcement in island reef engineering, and in particular to a rapid solidification method of calcareous sand.

### BACKGROUND

Calcareous sand particles on coral reefs have internal pores, irregular shapes, and low particle strengths, and are prone to particle breakages. Environments in tropical and subtropical sea areas are harsh, with frequent storms and frequent precipitations. Especially in an early stage of a hydraulic fill construction, the calcareous sand particles are loose and are easy to be lost by a short-term heavy rainfall and a tidal scouring. If prevention and control are not carried out, a stability of a project is adversely affected. Therefore, the application provides a rapid solidification method of calcareous sand, so as to improve an anti-erosion performance of the calcareous sand and keep a good engineering stability under harsh natural conditions, so the method is of great significance to the field of island reef engineering construction.

### SUMMARY

Based on the above, the application provides a rapid solidification method of calcareous sand, so as to improve an anti-erosion performance of the calcareous sand and enable the calcareous sand to maintain a good engineering stability under harsh natural conditions.

To achieve the above objective, the application provides following solutions.

A first technical scheme according to the application is the rapid solidification method of the calcareous sand, which realizes a rapid solidification of the calcareous sand by applying a zinc sulfate solution to the calcareous sand.

In an embodiment, the zinc sulfate solution is a zinc sulfate aqueous solution; and a concentration of the zinc sulfate aqueous solution is 0.4-1.4 mol/L.

In an embodiment, an application mode is spraying; a hydraulic force in a spraying process is 2-5 L/min·m², and a wetting depth of the solution is not less than 3 cm.

In an actual construction process, the solution concentration and times of spraying reinforcements may be determined according to an actual situation.

In an embodiment, the application mode is grouting; and a grouting pressure is 0.5-1.0 MPa.

In an embodiment, the method further includes a step of tamping the calcareous sand before applying the zinc sulfate solution to the calcareous sand.

In an embodiment, the method further includes a step of heating after applying the zinc sulfate solution to the calcareous sand.

In an embodiment, a heating temperature is 40-60° C. and a duration is 0.5-2 hours.

Adding the zinc sulfate solution to the calcareous sand for the reinforcement may be carried out at a room temperature, and heating after adding the zinc sulfate solution is to obtain a better reinforcement effect. In an actual construction process, if a site temperature is high, such as a ground temperature may reach above 50 degrees in a high temperature weather of the South China Sea, the effect after a heating treatment may be achieved without an additional heating operation.

A second technical scheme of the application is a slope reinforcement method of a calcareous sand foundation pit, which realizes the reinforcement by spraying the zinc sulfate solution on a surface of the calcareous sand foundation pit.

A third technical scheme of the application is a reinforcement method for erosion prevention of a calcareous sandy beach, which realizes the reinforcement by spraying the zinc sulfate solution on a surface of the calcareous sandy beach.

A fourth technical scheme of the application is a reinforcement method for preventing a calcareous sand particle loss in a hydraulic fill process of an island reef. The zinc sulfate solution reacts chemically with the calcareous sand to generate gypsum and zinc carbonate minerals by spraying the zinc sulfate solution on a calcareous sand surface, and calcareous sand particles are cemented to reinforce the sand.

Reinforcing the calcareous sand by using the zinc sulfate solution in a hydraulic fill construction may avoid a sand loss caused by a wave erosion in the hydraulic fill construction.

A fifth technical scheme of the application is a reinforcement method for a calcareous sand foundation, which realizes a foundation reinforcement by injecting the zinc sulfate solution into the calcareous sand foundation through a pressure grouting.

A technical conception of the application.

More than 90% of a mineral composition of the calcareous sand is calcite, and a chemical composition of the calcite is calcium carbonate (CaCO₃). Zinc sulfate (ZnSO₄) is selected for a chemical reinforcement of the calcareous sand. Calcium carbonate reacts with zinc sulfate to form two solid substances, smithsonite (ZnCO₃) and gypsum (CaSO₄·2H₂O), so that a generation of some by-products and a harm to the environment is avoided. Moreover, a strength of the calcareous sand is not weakened since an acidic environment is not produced when zinc sulfate reacts with the calcite. A corresponding chemical reaction formula is as follows:

Zn²⁺+SO₄²⁻+CaCO₃→ZnCO₃↓+CaSO₄·2H₂O↓

According to the above reaction, the calcium sand is treated with the zinc sulfate solution, and Ca²⁺and Zn²⁺exchange in calcite lattices to form smithsonite (ZnCO₃) and gypsum (CaSO₄·2H₂O). In a calcite group, smithsonite is a kind with a high hardness and a high specific gravity, and is insoluble in water and nontoxic. A Mohs hardness of smithsonite is 4.5, 50% higher than that of calcite with the Mohs hardness of 3, so the hardness of the calcareous sand particles is improved and particle breakages are reduced. The other product is gypsum, and gypsum is white, non-toxic and insoluble in water. Smithsonite and gypsum are filled in pores of the calcareous sand particles as cements, forming an interconnected network structure among the calcareous sand particles, filling the pores of the calcareous sand particles themselves, and making the calcareous sand denser.

The application discloses following technical effects.

The method according to the application is simple and convenient to operate, and may be applied to a site of a hydraulic fill project of the island reef in the South China Sea. Compared with a microbiologically induced calcite precipitation (MICP) technology, since the MICP technology needs a series of complicated operations such as a bacterial inoculation, a culture, a separation and a purification to reinforce the calcareous sand and is difficult to carry out a large-scale engineering application, the method according to the application is superior to the MICP technology in terms of a feasible engineering application.

The reinforcement effect of the method according to the application is good, and it may be seen from a uniaxial compression test that the reinforcement effect of the method according to the application is better than that of a MICP method.

Urea-hydrolyzing bacteria used by MICP technology to reinforce the calcareous sand is expensive, while the method according to the application only uses the zinc sulfate aqueous solution as the reinforcement liquid, so a cost is low.

The method according to the application has a good environmental adaptability, and reaction products of the method according to the application are smithsonite and gypsum, and both minerals are solid substances harmless to the environment and insoluble in water. However, the bacteria used by MICP technology to reinforce the calcareous sand are difficult to adapt to an extreme environment of the South China Sea project site. The extreme environment may cause a large number of bacterium to die, thus greatly weakening the reinforcement effect. Moreover, an ecological safety monitoring of microorganisms after injecting bacterial solution is also a problem to consider.

The method according to the application has a high reinforcement efficiency, and it may be seen from a penetration test that a surface strength reaches a peak value after about 4 hours of the reinforcement, and then the surface strength hardly changes, showing that the reinforcement liquid almost completely reacts after 4 hours of the reaction. At 2 hours, the surface strength may reach 65% of a peak strength, indicating that at 2 hours, most of the reinforcement liquid has already participated in a chemical reaction. This result shows that a chemical reaction efficiency of the method according to the application is very high, and a possibility and an effect of rescuing the project in some unexpected situations, such as a seepage prevention and a reinforcement for slope protection before a storm, are improved.

### BRIEF DESCRIPTION OF THE DRAWINGS

In order to more clearly explain embodiments of the application or technical solutions in the prior art, the following introduces drawings to be used in the embodiments. Obviously, the drawings in the following description are only some embodiments of the application. For those of ordinary skill in the art, other drawings may be obtained according to these drawings without any creative efforts.

FIG. 1 shows photos before and after a calcareous sand reinforcement in embodiment 1 of the application, in which a left figure is a photo before the calcareous sand reinforcement, and a right figure is a photo after the calcareous sand reinforcement.

FIG. 2 shows scanning election microscope (SEM) images before and after a calcareous sand reinforcement in embodiment 1 of the application, in which the upper left image and the lower left image have a magnification of 200 times, and the upper right image and the lower right image have the magnification of 300 times.

FIG. 3 is a photo of a sample prepared in embodiment 2 of the application for a uniaxial compression test.

FIG. 4 shows a uniaxial compressive strength test result and a corresponding linear fitting curve of cylindrical samples of reinforced calcareous sand under different concentrations of zinc sulfate solutions in embodiment 2 of the application.

FIG. 5 shows a change rule of a penetration resistance with depth after a reinforcement of calcareous sand under different concentrations of zinc sulfate solutions in embodiment 3 of the application, in which,

a represents the change rule of the penetration resistance with depth after the reinforcement with 0.4 mol/L zinc sulfate solution;

b represents the change rule of the penetration resistance with depth after the reinforcement with 0.6 mol/L zinc sulfate solution;

c represents the change rule of the penetration resistance with depth after the reinforcement with 0.8 mol/L zinc sulfate solution;

d represents the change rule of the penetration resistance with depth after the reinforcement with 1.0 mol/L zinc sulfate solution;

e represents the change rule of the penetration resistance with depth after the reinforcement with 1.2 mol/L zinc sulfate solution; and

f represents the change rule of the penetration resistance with depth after the reinforcement with 1.4 mol/L zinc sulfate solution.

### DETAILED DESCRIPTION OF THE EMBODIMENTS

Various exemplary embodiments of the application are described in detail. This detailed description should not be taken as a limitation of the application, but should be understood as a more detailed description of some aspects, characteristics and embodiments of the application.

It should be understood that terms mentioned in the application are only used to describe specific embodiments, and are not used to limit the application. In addition, for a numerical range in the application, it should be understood that each intermediate value between an upper limit and a lower limit of the range is also specifically disclosed. Every smaller range between any stated value or the intermediate value within the stated range and any other stated value or an intermediate value within the stated range is also included in the application. The upper and lower limits of these smaller ranges may be independently included or excluded from the range.

Unless otherwise stated, all technical and scientific terms used herein have the same meanings commonly understood by those of ordinary skill in the field to which this application relates. Although the application only describes preferred methods and materials, any methods and materials similar or equivalent to those described herein may be used in the practice or testing of the application. All documents mentioned in this specification are incorporated by a reference to disclose and describe the methods and/or materials related to the documents. In case of a conflict with any incorporated documents, the contents of this specification shall prevail.

Without departing from a scope or a spirit of the application, it is obvious to those skilled in the art that many modifications and changes may be made to the specific embodiments of the present specification. Other embodiments obtained from the description of the application are obvious to the skilled person. The description and the embodiments of the application are only exemplary.

As used in this paper, the terms “including”, “including”, “having” and “containing” are all open terms, meaning including but not limited to.

“Parts” mentioned in the application refers to the parts by mass unless otherwise specified.

### Embodiment 1

Calcareous sand is reinforced as follows: 50 milliliters of 0.8 mol/L zinc sulfate solution is sprayed on a calcareous sand surface, and changes of micro-morphology after 24 hours are observed.

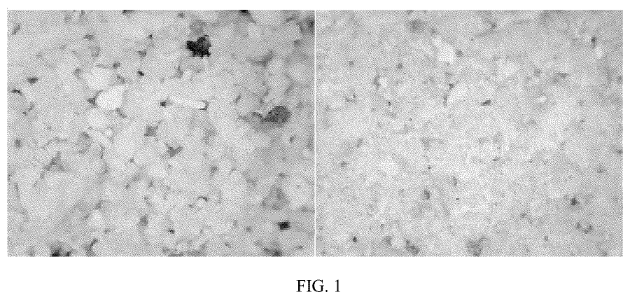

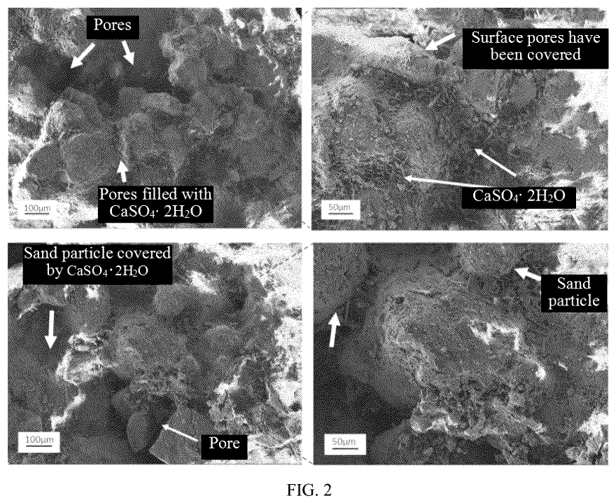

In this embodiment, photos and scanning election microscope (SEM) images before and after a calcareous sand reinforcement are shown in FIG. 1 (photos) and FIG. 2 (SEM images) respectively. In FIG. 1, a left figure shows the photo before the calcareous sand reinforcement and a right figure shows the photo after the calcareous sand reinforcement. In FIG. 2, an upper left figure and a lower left figure have a magnification of 200 times, and an upper right figure and a lower right figure have the magnification of 300 times. FIG. 2 shows that gypsum precipitates generated by a reaction fill internal voids and inter-particle gaps of calcareous sand particles, and form cementation between the particles. The cementation between the particles not only makes a porosity of the calcareous sand decrease significantly, but also makes original angular edges of the calcareous sand particles become smooth, and further enlarges a contact surface between the particles, thus reducing a stress concentration and particle breakages.

The calcareous sand particles are loose and have no cohesive force before the reinforcement, so a particle loss is easy to occur under a scouring action of a water flow. The gypsum is formed between the particles and in pores of the reinforced calcareous sand, and the loose particles are cemented; therefore, a strength and a compactness of the reinforced calcareous sand are significantly improved, and the reinforced calcareous sand has an excellent resistance to a water flow erosion. Comparing the calcareous sand before and after the reinforcement (FIG. 1), it may be clearly seen that the surface of the reinforced calcareous sand is denser and the pores are filled. After a SEM microscopic test of the reinforced calcareous sand (FIG. 2), it may be observed that the pores on the surfaces of the calcareous sand particles are all covered by products, and no obvious pores may be seen among the particles.

### Embodiment 2

A uniaxial compressive strength is often used to evaluate a reinforcement effect. Mechanical properties of the reinforced calcareous sand are evaluated by a uniaxial compression test and a penetration test, and the reinforcement effect is tested and compared with that of microbiologically induced calcite precipitation (MICP) reinforcement technology.

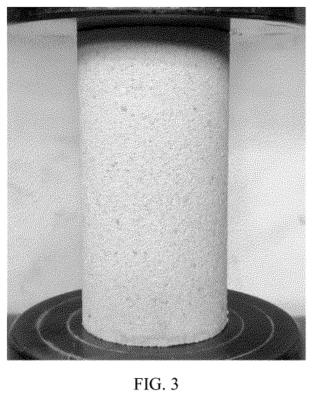

In the uniaxial compression test using a reinforcement method according to the application: a multifunctional hydraulic prototype is used for a sample preparation, and each sample used for the uniaxial compression test has a diameter of 50 mm and a height of 100 mm; after the sample (as shown in FIG. 3) is made, each sample is put into a small amount of reinforcement liquid (300 milliliters) for standing for 3 hours, so as to make the reinforcement liquid react with the calcareous sand particles in the sample; then, the sample is taken out, the surface moisture is wiped off, and a sand column sample is put in an oven at 50° C. for curing for about 48 hours until a sample quality does not change; and the uniaxial compression test is conducted at a loading rate of 1.0 mm/min until the sample is damaged.

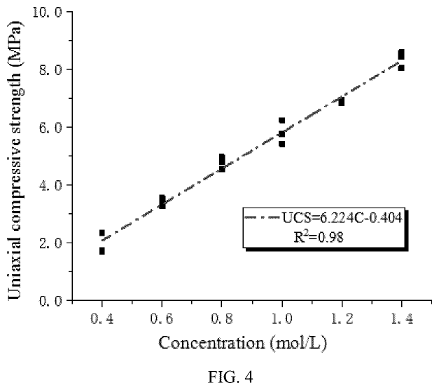

FIG. 4 shows a uniaxial compressive strength curve and a corresponding linear fitting curve of cylindrical samples of reinforced calcareous sand under different concentrations of zinc sulfate solutions obtained by the method according to the application. It may be seen that there is a good linear relationship between the concentration of the reinforcement liquid and the uniaxial compressive strength of a sand column; with an increase of the concentration, the uniaxial compressive strength increases linearly; in the method according to the application, the uniaxial compressive strength of the sand column may reach 2.0 MPa with 0.4 mol/L of the reinforcement liquid, while the maximum uniaxial compressive strength of the sand column may reach 8.59 MPa with 1.4 mol/L of the reinforcement liquid. The results show that the reinforcement effect of the method according to the application is obvious.

Consult related literatures about MICP (microbiologically induced calcite precipitation) reinforced calcareous sand ([1] Li Hao, Tang Chaosheng, Liu Bo, Lyu Chao, Cheng Qing, Shi Bin. Mechanical properties of MICP solidified calcareous sand in simulated seawater environment [J]. Journal of Geotechnical Engineering, 2020, 42 (10): 1931-1938; [2] Liu L, Liu H, Stuedlein A W, et al. Strength, stiffness, and microstructure characteristics of biocemented calcareous sand [J]. Canadian Geotechnical Journal, 2019, 56 (10): 1502-1513. DOI: 10.1139/cgj-2018-0007. [3] Dong Bowen, Liu Shiyu, Yu Jin, Xiao Yang, Cai Yanyan, Tu Bingxiong. Evaluation of effect of natural seawater on calcium sand reinforcement based on microbiologically induced calcium carbonate precipitation [J]. Geotechnical Mechanics, 2021, 42 (4): 1104-1114. et al.). Compared with the uniaxial compressive strengths of the calcareous sand columns reinforced by the MICP technology, it may be seen that the uniaxial compressive strengths of the calcareous sand columns reinforced by the MICP technology are mostly around 2 MPa, and the uniaxial compressive strengths of the calcareous sand columns reinforced by the method according to the application are much higher than the uniaxial compressive strengths of the calcareous sand columns reinforced by the MICP.

It is worth noting that a period of a sand column reinforcement by the method according to the application is only 3 hours, that is, the sand column is soaked with the reinforcement liquid, and a volume of the reinforcement liquid used for soaking is only 300 milliliters, while a reinforcing process of a MICP method is roughly as follows: a grouting liquid includes a bacterial solution, a fixing liquid and a mineralizing solution which are in a stable period after 48 hours of culture; effective components in the mineralizing solution are urea and calcium chloride, and their molar ratio is 1:1; during a grouting reinforcement, 100 milliliters of the bacterial solution (about 1.5 times the volume of a sand column) is injected first, 10 milliliters of the fixing liquid (0.05 mol/L CaCl2) is injected after an interval of 6 hours, and then the mineralizing solution is injected after the interval of 6 hours to complete a reinforcement treatment for one day. In order to ensure a mineralization effect, a duration of reinforcing the calcareous sand with the MICP is set to 5 days.

It may be seen that the period of reinforcing the calcareous sand by the MICP method is much longer than the period by the method according to the application, so the MICP method may not be used for an engineering rescue. The process of the MICP method is complicated and is far less simple and practical than the method according to this application. Moreover, the effect of the reinforced calcareous sand by the MICP method is not as good as that of the method according to the application.

### Embodiment 3

The penetration test of the calcareous sand after the surface reinforcement is carried out to study the reinforcement effect of the reinforcement liquid with different concentrations and an increasing law of a surface strength with time. The reinforcement method of the calcareous sand is as follows: site reinforcement conditions are simulated in a laboratory. Calcareous sand samples are put into a round container, and a surface reinforcement test simulates the reinforcement of the calcareous sand surfaces by spraying and moistening. The test sand is the original graded calcareous sand taken from an island reef in Nansha Islands. Oversized gravel blocks are removed, and the calcareous sand is not treated at all, so as to keep its original properties, so as to simulate an actual engineering reinforcement environment of the island reef in the South China Sea. The concentrations of the zinc sulfate solutions are set to 0.4 mol/L, 0.6 mol/L, 0.8 mol/L, 1.0 mol/L, 1.2 mol/L and 1.4 mol/L. The reinforcement liquids are evenly sprayed on the calcareous sand surfaces by a spraying process. The volumes of the reinforcement liquids used in all reinforcement tests are the same (about 80 g), an immersion depth is 3 cm, and a reaction environment temperature is kept at 27° C. After the reinforcement, the surface strength is tested by a micro-penetrometer. A diameter of a probe needle is 2.0 mm and a penetration rate is 5 mm/min.

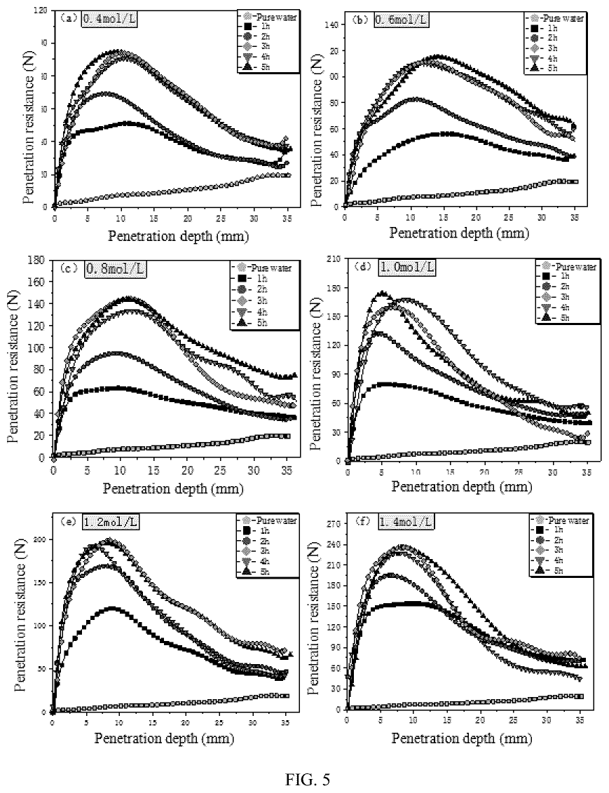

FIG. 5 shows a change rule of a penetration resistance with depth. It may be seen that the penetration resistance increases rapidly with a penetration depth, and then enters a relatively stable stage, and gradually decreases, and finally fluctuates in a lower range and tends to be stable. This shows that the reinforcement effect is mainly concentrated on a shallow surface, because the calcareous sand at a surface layer is fully contacted with the reinforcement liquid under an action of spraying, so a stronger particle cementation is formed, while the calcareous sand at a lower layer is less contacted with the reinforcement liquid, so the cementation is weak. It may be seen that when the strength tends to be stable, the penetration strength is discrete to some extent, because the reinforcement liquid contacted by the lower calcareous sand is infiltrated by the reinforcement liquid sprayed on the surface along the pores between the particles. Therefore, due to an irregularity of a particle arrangement, the amount of the reinforcement liquid contacted by each place in the lower layer is different, so a cementation degree of each place in a lower part is uneven. However, an overall trend of the stable penetration resistance increases with time.

In order to show the reinforcement effect more intuitively, pure water (about 80 g) with the same volume as the reinforcement liquid used in the penetration test is added into the sample, and then the penetration test is carried out. The pure water is only added to make the sample achieve a same wetting effect as that of the reinforcement liquid, but does not cement the sample. From test curves, it may be seen that a penetration curve of the sample only added with the pure water is quite different from that of the sample using the reinforcement liquid. With the increase of a penetration depth, the penetration resistance increases approximately linearly, and there is no situation similar to a rapid rise of the penetration resistance at the initial stage of the penetration after the use of reinforcement fluid.

Indoor tests of embodiments 1-3 prove an excellent solidification effect of the method according to the application on the calcareous sand, indicating that the method according to the application may be used in a hydraulic fill project of the island reef in the South China Sea.

In a practical application, 0.6-1.4 mol/L reinforcement liquid (zinc sulfate aqueous solution) may be selected for a slope surface reinforcement, and a reinforcement depth is not less than 3 cm. It is recommended to use a high concentration zinc sulfate solution for a slope stabilization in case of a sudden rainstorm. The reinforcement liquid with a high concentration may be selected for a foundation reinforcement. Because of a complex environment of a project site, an addition amount and reinforcement times should be determined according to actual project requirements.

The reinforcement liquid (zinc sulfate aqueous solution) is prepared with the pure water, and the contact between the solution and vulnerable parts of a body should be avoided during a preparation process. Considering a rapid response and the obvious reinforcement effect of this method, for some projects that need the surface reinforcements, such as a slope reinforcement of a calcareous sand foundation pit, a scouring reinforcement of a beach and the reinforcement for a particle loss prevention during a hydraulic fill process of the island reef, it is recommended to use a spraying device and adopt a spraying process (the solution concentration is 0.6-1.4 mol/L, and a spraying amount should not be less than a pore volume of the calcareous sand to be reinforced), and a hydraulic power may be controlled at 2-5 L/min·m² during the spraying reinforcement process. Moreover, The solution should be sprayed evenly, and a recommended wetting depth of the solution is about 5 cm. The solution concentration and the times of the spraying reinforcement may be determined according to the actual situation. For a foundation reinforcement, a conventional pressure grouting method may be used, a grouting pressure is 0.5-1.0 MPa, and the reinforcement liquid is injected into the calcareous sand.

In an embodiment, the surface layer of the calcareous sand foundation sprayed with the reinforcement liquid is compacted by a vibratory roller, so that a compaction degree of the calcareous sand reaches more than 80%. Then, the spraying reinforcement of 2-5 L/min·m² is carried out again (the concentration of the solution is 0.6-1.4 mol/L, and a spray amount should not be less than the pore volume of the calcareous sand to be reinforced). After a completion, a weight (50 kg/m²) is covered on the reinforced sand body, and the reaction process is maintained, so that the foundation may reach a consolidated and dense state.

In an embodiment, the reinforced sand body is covered with the weight (50 kg/m²), and the compacted calcareous sand body is heated after a reaction process is kept compact for about 1 day. The temperature is controlled at 40-60° C. and the duration is 0.5-2 hours. A site working condition is complex, when there is no corresponding equipment, the solidification may be carried out in a high temperature and little rain weather to promote a conversion of internal dihydrate gypsum into hemihydrate gypsum further improving the reinforcement effect (in fact, a site ground temperature may reach more than 50 degrees in a high temperature weather of the South China Sea, and the effect after the heating treatment may be achieved without additional heating operation). The sand body shall not be trampled or disturbed during and after the reinforcement, so as not to damage the cementation between the particles.

The zinc sulfate used in this method is completely soluble in water. This means that toxicological effects in an aquatic environment must be considered. The zinc sulfate solution has no irritation to a skin, and may be used as a nutrient for animals with zinc deficiency, a feed additive for animal husbandry, and a zinc fertilizer for crops. The zinc sulfate solution reacts with the calcareous sand to produce smithsonite and gypsum. The two minerals are solid substances harmless to the environment and insoluble in water. Zn²⁺is considered harmless, and even used as a dietary supplement in some cases. Meanwhile, there are a lot of Zn²⁺and SO₄²⁻in seawater, so a proper amount of zinc sulfate solution is harmless to a marine environment. Moreover, the reaction efficiency of this method is very high, and a reinforcement reaction may be completed within a few hours, so a proper operation does not cause environmental and ecological problems.

The above-mentioned embodiments only describe preferred modes of the application, but do not limit the scope of the application. On a premise of not departing from a design spirit of the application, all kinds of modifications and improvements made by ordinary technicians in the field to the technical scheme of the application shall fall within the scope of protection determined by claims of the application.

What is claimed is:

1. A rapid solidification method of calcareous sand, wherein a rapid solidification of the calcareous sand is realized by applying a zinc sulfate solution to the calcareous sand.

2. The rapid solidification method of the calcareous sand according to claim 1, wherein the zinc sulfate solution is a zinc sulfate aqueous solution; and a concentration of the zinc sulfate aqueous solution is 0.4-1.4 mol/L.

3. The rapid solidification method of the calcareous sand according to claim 1, wherein an application mode is spraying; a hydraulic force in a spraying process is 2-5 L/min·m², and a wetting depth of the solution is not less than 3 cm.

4. The rapid solidification method of the calcareous sand according to claim 1, wherein the application mode is grouting; and a grouting pressure is 0.5-1.0 MPa.

5. The rapid solidification method of the calcareous sand according to claim 1, further comprising a step of tamping the calcareous sand before applying the zinc sulfate solution to the calcareous sand.

6. The rapid solidification method of the calcareous sand according to claim 5, further comprising a step of heating after applying the zinc sulfate solution to the calcareous sand; and a heating temperature is 40-60° C. and a duration is 0.5-2 hours.

7. A slope reinforcement method for a calcareous sand foundation pit and beach erosion prevention, wherein the reinforcement is realized by spraying zinc sulfate solutions on surfaces of the calcareous sand foundation pit and calcareous sandy beach.

8. A reinforcement method for preventing a calcareous sand particle loss in a hydraulic fill process of an island reef and a calcareous sand foundation, wherein the reinforcement is realized by spraying a zinc sulfate solution on a surface of the calcareous sand foundation to form gypsum and zinc carbonate cement.
